(19) United States
(12) Patent Application Publication
(10) Pub. No.: US 2004/0094529 A1
(43) Pub. Date: May 20, 2004

(54) Heating and method for controlling heating of a functional unit on a motor vehicle

(76) Inventor: Stefan Richter, Michelau (DE)

Correspondence Address: CHRISTIE, PARKER & HALE, LLP, 350 WEST COLORADO BOULEVARD, SUITE 500, PASADENA, CA, 91105, US

(21) Appl. No.: 10/473,660

(22) PCT Filed: Apr. 16, 2002
(86) PCT No.: PCT/DE02/01463

(30) Foreign Application Priority Data
Apr. 25, 2001 (DE) 101-20-098.6

(51) Int. Cl. B60L 1/02

(52) U.S. Cl. 219/202

(57) ABSTRACT

Heating of the functional unit is started manually or automatically by means of a control device. An actual temperature or a parameter dependent on the actual temperature is monitored during, and optionally before and after the actual heating of the functional unit. Depending on the environmental conditions, such as air temperature or heat transfer resistance the dynamics of the values, thus the time-dependence of the parameters can vary widely. A characteristic feature of the time course of the actual temperature or of the parameters dependent on the heating temperature, which determines the phase transition of water, serves for the evaluation and control of the heating. One characteristic feature is, for example, the speed of cooling of the functional unit during a heating pause. Analysis of the characteristic features is used to control the heating power of the heating elements. Threshold values and further factors such as proportionality factors for the controller, for example, are determined depending upon significant characteristics. The threshold values and factors are also particularly used for a subsequent starting of the heating, for example, after 24 hours, using the corresponding analysis and control.

### DESCRIPTION

The invention relates to heating and method for controlling heating of a functional unit on a motor vehicle.

Heatings of functional units on motor vehicle are on the one hand electric where heating resistances are fed from the battery or generator (alternator) or on the other hand through the air heated by the engine. Heating a wing mirror, lock or windscreen of a vehicle is usually undertaken by at least one electric heating element whose heating power can be controlled electrically for example by an operator switch.

From EP 0 408 853 A2 heating a vehicle wing mirror is known where, for heating, the current flow through a heating conductor is controlled by a semi-conductor switch. The semi conductor switch is controlled through a temperature sensor and a two-stage amplifier circuit which behaves like a Schmitt trigger. The semi conductor switch thereby forms one of the two stages which are coupled together for the Schmitt Trigger behaviour. The drawback with this solution is that when the temperature drops below 27° C. the heating current is switched on until a temperature of 30° C. is reached even if heating is not necessary for clear view of the mirror surface. The amount of energy required for the heating device for the mirror glass is therefore unnecessarily high.

From DE 197 05 416 C1 a method is known for controlling the heating of a rear windscreen of a vehicle where the heating of the rear windscreen is switched off at least after a certain switch-on time. The certain switch-on time of the rear windscreen heater is extended as the drive speed of the vehicle increases. This extension of the switch on time can also lead to strain on the on-board power supply or vehicle battery without any benefits to the vehicle occupants.

In DE 91 08 801 U1 a voltage drop which is dependent on the temperature of the mirror glass is compared by a comparator with a reference value and a switch of the comparator is controlled in dependence on the result of the comparison. The heating current is for this purpose compared with a reference value. A control device containing the comparator is for heating the mirror glass on a vehicle wing mirror provided with a heating resistance which can be switched to a current source by means of a switch. The voltage drop at a resistance through which the heating current flows is detected by a comparator and compared with a reference value. The switch of the comparator is controlled in dependence on the result of the comparison. The use of the temperature path of the specific resistance of the heating resistance is based on the fact that the temperature of the heating resistance which rests with its full or partial surface on the mirror glass corresponds, when the heating current is interrupted, roughly to a mean value of the temperatures of the different mirror glass regions. A high set reference value or a large manufacturing tolerance of the heating resistance leads in turn to a poor energy utilisation of the vehicle battery.

The object of the invention is to provide heating and a method for controlling the heating for a functional unit on a motor vehicle which reduces the energy consumption required by the heating.

This is achieved through the method having the features of patent claim 1 and through heating having the features of patent claim 15. Advantageous further developments of the invention are to be concluded from the sub claims.

Accordingly the heating of the functional unit is started automatically or manually by a control device. Starting is triggered for example by operating a manual actuating device, remote control, button or switch when the vehicle detects that the heating of the functional unit is required for proper functioning of the unit. Alternatively starting is carried out automatically by the control device generally starting up the heating to ensure functional reliability or by the control device recognising that inadequate functional reliability is probable. By way of example detecting that the door lock will not function properly due to icing up leads to an automatic starting of the heating and thus to thawing of the door lock.

An actual temperature or a parameter dependent on the actual temperature is determined. The actual temperature is dependent on the temperature of an element of the functional unit which is to be heated or is dependent on the temperature of the heating element of the heater. The actual temperature is consequently a specific preferably measured input value of the thermal system comprising the heating and the functional unit which is to be heated. The actual temperature is correlated during the actual heating time period, thus the time of the supply of heating energy to the actual heating temperature. In addition one or more ideal temperatures can be provided which as comparison value depict the desired temperature of the heated functional unit in dependence on the different operating modes of the heating. As parameter is used an electronically evaluated value, such as the power take-up, energy take-up or the power balance of the heating and in particular a measured value. The dynamics of the values, thus the time dependence of the parameters can vary considerably in dependence on the surrounding conditions, such as air temperature or heat transfer resistance etc. For simplicity, the actual value is detected in binary steps for example so that the range from −40° C. to +87° C. is divided into 128 binary steps.

Characteristic features of the time path of the actual temperature or of the parameter dependent on the actual temperature serve to evaluate and control the heating. A characteristic feature is by way of example the speed of cooling of the functional unit during a heating pause. If for example the cooling stagnates in the region of 0° C. heating temperature, although the air temperature is clearly below 0° C. then icing up of the functional unit which is found in the process is detected by the control device and the heating power is correspondingly raised for the control.

Characteristic features of this time path which determine the phase transition of water are evaluated according to the invention. The water causes functional breakdowns through icing or misting up of the previously mentioned functional units of the vehicle. The phase transitions of the water from the solid to the liquid phase or to the vapour phase which might possibly take place during heating or during the cooling phase thereby generate characteristic features of the time path of the actual temperature which are evaluated for controlling the heating until preferably the functional breakdown caused by the water has been cleared. The characteristic features of the time path of the actual temperature determining the phase transition of water can be determined for example by integration, simple or multiple derivation according to the time, through transformation or convolution. Determining the actual temperature can to this end take place quasi continuously for example. More advantageously measuring time points are used which are adapted to the changing speed of the temperature and in addition whose number in the vicinity of the characteristics can be varied.

The evaluation of the characteristic features is consequently used to control the heating power of the heating element. Several parameters can thereby be evaluated at the same time. For evaluating or analysis the characteristic features in a first design variation are used directly for control so that determined values are used identically. Preferably in a second design variation as an alternative images or transformations of the characteristic features are used for control. By way of example a special characteristic feature is copied to the associated actual temperature, more particularly a phase transition is transformed to the temperature of the phase transition. This transformation can include the displacement of the phase transition in dependence on further parameters, for example the convection produced through the drive speed or the actual air pressure. In dependence on the significant characteristics for example threshold values and further factors such as proportionality factors are determined for the control. More particularly the threshold values and factors are also used for a later starting of the heating, for example after 24 hours, with the associated evaluation and control.

If the method or the control device is used for example for a vehicle wing mirror or composite glass pane then advantageously it is ensured that a critical actual temperature which could lead to breakage of the functional unit is not reached in that the heating is controlled using characteristic features, preferably the heating power is turned down before reaching the critical actual temperature or after phase transition has taken place or the heating is switched off completely.

In an advantageous development of the invention the heating then changes into a second mode. In this second mode different types of operation are possible. In order to reduce the energy consumption of the heating the heating is advantageously switched off, turned down, regulated to a constant temperature or temporarily switched on and off in specific cycles. Also these types of operation can be combined with a previously mentioned monitoring. The type of operation or a combination of several modes of operation depends in particular on the functional unit and on external environmental factors, such as rain, snow etc.

A preferred further development of the invention proposes that the actual temperature or the parameter dependent on the actual temperature is determined before and/or after a heating time period. Thus at least outside of the heating time periods, preferably also during the same, monitoring of the actual temperature takes place, which can advantageously be used to increase or reduce the heating power, to switch the heating on and off. Preferably before the heating time period the phase transition of water is determined and in dependence on the determined phase transition the heating is automatically started or the heating power is increased. This is particularly advantageous therefore since during driving, rapid outside temperature changes, for example when driving up into mountains, can lead to icing up of a wet vehicle wing mirror.

If the heating however is only supplied with current during an actual heating phase in order to minimise the current consumption during the non-active times, for example when the ignition is switched off, in a further alternative embodiment of the invention the actual temperature or the parameter dependent on the actual temperature is determined only during a heating time period.

In a preferred embodiment of the invention the control device has means for evaluating different actual temperature rising speeds as characteristic features. In the previously mentioned example of a compound glass pane which is “misting up”, thus on which small water droplets have settled the heating is operated until reaching the evaporation temperature, thus for example 50° C. After another raised actual temperature rising speed the actual temperature is kept constant through a corresponding regulation since the drops have already evaporated from the surfaces of the window pane. The means used are preferably an analogue or digital computer mechanism, more particularly an arithmetic logic unit with difference and division functions or algorithms. The dynamics of the temperature rise during the heating phase or the temperature drop during the heating pause or cooling phase are thus particularly advantageously evaluated.

In a further advantageous development of the invention the heating element is a temperature-dependent heating resistance through which a heating current flows for heating. Particularly advantageously the temperature-dependent heating resistance or a measured value dependent on the temperature-dependent heating resistance is used as the parameter. In order to determine the heating resistance it is possible to use for example a temporary wiring circuit as measuring bridge, resonant circuit or the like. For this the temperature-dependent heating resistance is connected to the control device. The heating power is controlled in dependence on the determined measured value or the determined heating resistance which is connected to a control element of the control device. Usually a heating resistance is used having a positive temperature coefficient. It is also possible however to use a heating resistance of semi conductor material with a corresponding negative temperature coefficient.

As a result of the large manufacturing tolerances of the heating resistance as well as its ageing effect and changes in the temperature coefficient of the heating resistance during manufacture and also during the service life thereof, measuring the heating resistance itself as input measured value for heating control is only reliably possible according to the invention. Only the inclusion of the underlying physical effect of the phase transition of water makes it possible, independently of the manufacturing and ageing tolerances of this measuring-heating resistance, to reliably detect the actual thermal state of the functional unit. If a phase transition is detected the measured values of the measuring-heating resistance for this phase transition are again set in proportion or the control takes place solely using the actual determination of a phase transition from the characteristics.

In a preferred development of the invention in addition the time change of the heating resistance or the measure value dependent on the heating resistance is evaluated for controlling the heating. The control device has here means, for example accumulator/memory and comparator, for evaluating the time change of the heating resistance or the measured value which is dependent on the heating resistance. If for example a micro computer unit is used for determining the time change then a clock, timer or impulse generator is connected to the micro computer unit.

In a further particularly advantageous development of the invention a value of the heating resistance or of the measured value dependent on the heating resistance is determined for a minimum of the time change (dR_{H}/dt). This determined value serves as the comparison value for the further evaluation and also subsequent evaluations. At least one threshold value for control is preferably determined from this value. If the value is obtained through several time-staggered determinations, several of these values are progressively averaged out in order to be able to evaluate long-term effects. Advantageously the value is stored for a melting temperature (0° C.). Thus icing up of the functional unit is determined particularly easily by the control device.

Furthermore it is advantageous if the threshold values or the value in the further development are compared with the heating resistance or the measured value through a comparator. The output value is then for example a binary signal from which the heating is controlled. The output value can also be a part of an algorithm with which the heating is controlled up or down accordingly. For a particularly simple evaluation the heating resistance or the measured value is compared by a window comparator as comparator with an upper threshold value and a lower threshold value. Accordingly the heating is switched off on exceeding the upper threshold value and is switched on again when falling below the lower threshold value. The threshold values are advantageously determined analogous with the evaluation of the changing speed.

Including the temperature coefficient of the heating resistance in the evaluation takes place in a further advantageous development of the invention. The temperature coefficient is previously determined by measuring technology, for example in a heat chamber, for a resistance material of one series. The heating is controlled in dependence on the value and temperature coefficient of the heating resistance. The actual temperature or a parameter dependent on the actual temperature is thereby advantageously determined by means of the value and the temperature coefficient from the heating resistance. The actual temperature can now be compared directly with the temperature of the atmospheric air which is determined by means of a temperature sensor of the vehicle.

A number of invention-related methods are offered for controlling the heating. For a heating resistance the heating voltage or the heating current can be varied, more particularly switched on or regulated as controllable values. In order to keep the wasted power of the control as low as possible the heating current is switched on in intervals to control the heating. The intervals are preferably variable in duration to regulate the temperature. If a faster regulation is required, particularly in the area of critical heating temperatures, then the heating current is more advantageously regulated by pulse width modulation for controlling the heating.

In order to prevent the functional unit from icing up the heating power is increased when the temperature of the functional unit drops in the region of about 0° C. The increase in the heating power is preferably switched on in dependence on the detection of ice formation. The detection of the ice formation thereby takes place through significant characteristics of the time path of the heating temperature over the time.

In addition a temperature sensor of the motor vehicle which measures air temperature and is independent of the heating is additionally evaluated for controlling the heating. If the windscreen wipers are not actuated for a longer time span then the heating of the functional unit for an air temperature above the region around 0° C. is not switched on since the control device expects neither rain nor ice which could impair the functional reliability. If the functional unit is nevertheless not capable of functioning because for example the vehicle wing mirror is covered with dew then a manual start of the heating is nevertheless possible by the vehicle occupant.

The invention will now be explained in further detail with reference to the embodiments illustrated in the drawings in which:

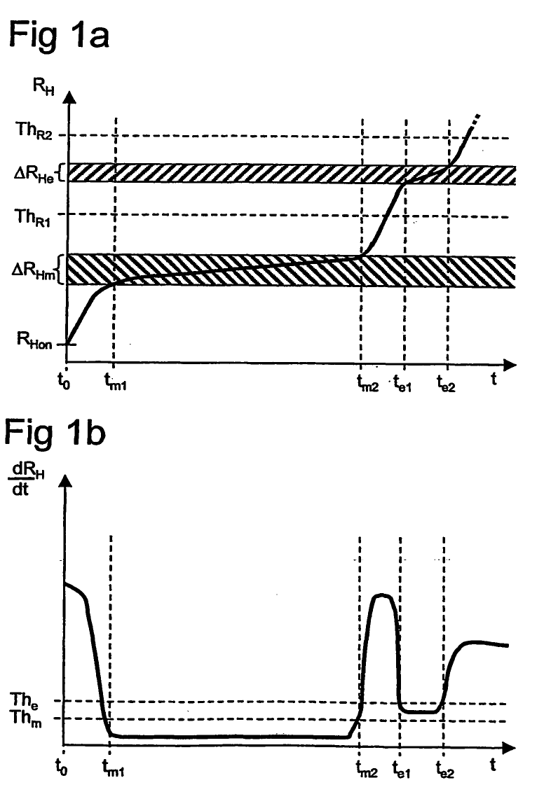

FIG. 1a shows a diagrammatic chart of the path of the heating resistance over time;

FIG. 1b shows a diagrammatic chart of the path of the time heating resistance change over time;

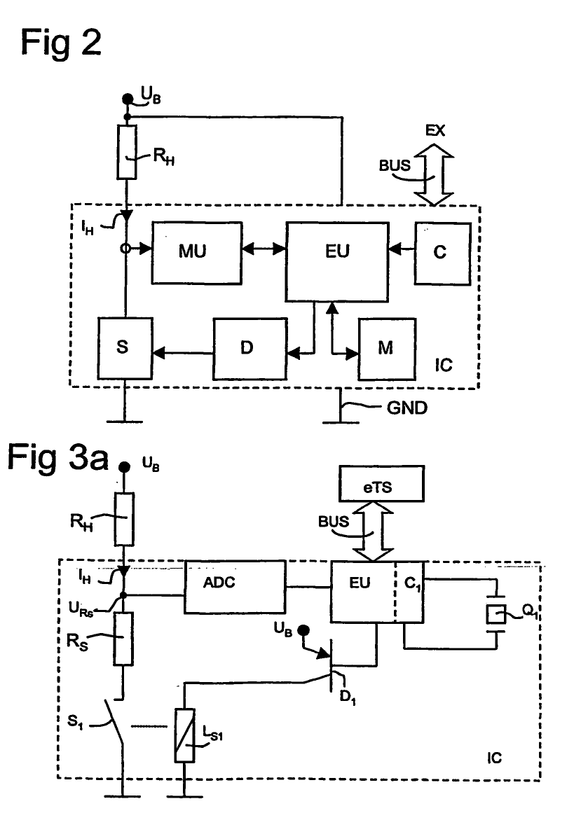

FIG. 2 shows a diagrammatic circuit plan of a control device;

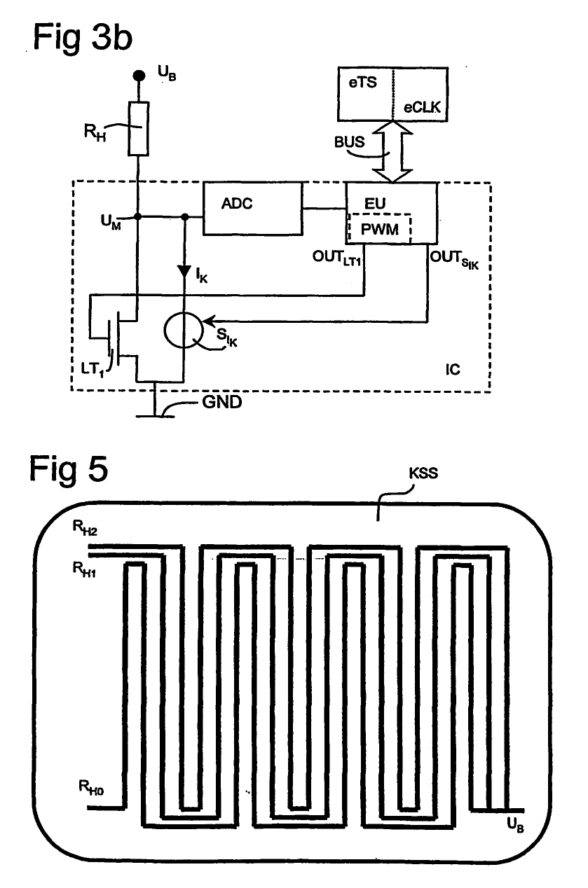

FIG. 3a shows a further diagrammatic circuit plan of a control device;

FIG. 3b shows a further diagrammatic circuit plan of a control device;

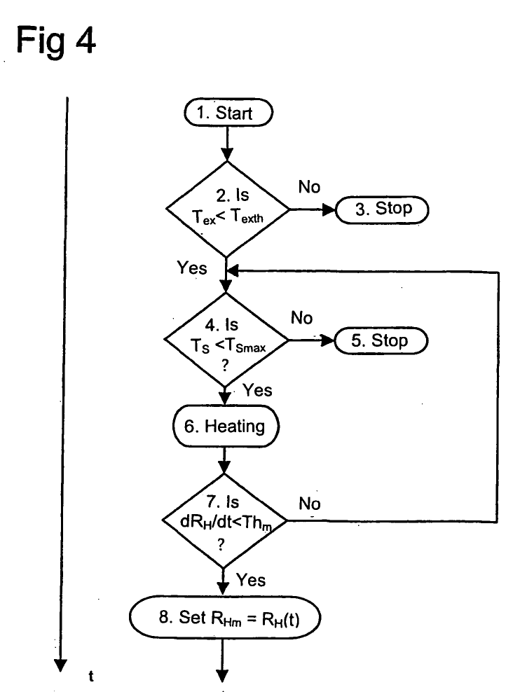

FIG. 4 shows a diagrammatic flow chart;

FIG. 4′ shows the continuation of the diagrammatic flow chart of FIG. 4; and

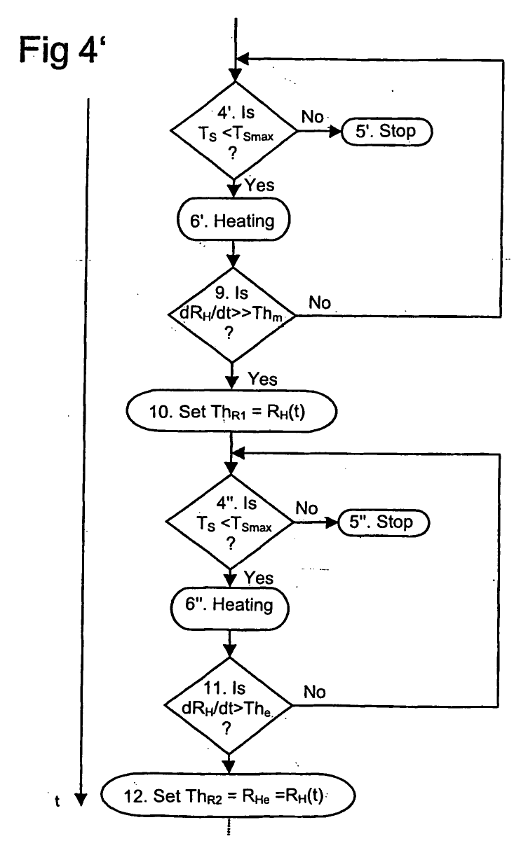

FIG. 5 shows a diagrammatic view of a vehicle mirror heating.

FIG. 5 shows a diagrammatic view of a vehicle wing mirror KSS. On the back of the mirror layer there are several heating resistances R_{H1}, R_{H2} and R_{H3} arranged directly adjoining one another. The heating resistances R_{H1}, R_{H2} and R_{H3} thereby take up the largest possible area of the effective mirror layer for the purpose of heating same. For heating, the heating resistances R_{H1}, R_{H2} and R_{H3} are connected individually in series or in parallel depending on the control. One of the heating resistances RH₁, R_{H2} and RH₃ is temporarily switched in as measuring resistance and its resistance value which in the ideal case is dependent linearly on the actual temperature is measured.

FIG. 1a shows a diagrammatic path (the thicker black line) of the heating resistance R_{H} (on the z-axis) over the time t (on the x-axis) in the form of a chart. The path is thereby purely by way of example. The path, more particularly its resistance changes and the time length ratios can vary in dependence on the heat transfer resistances, heat capacities, air pressure, atmospheric temperatures and further factors. It is nevertheless first assumed that the resistance change of the measured heating resistance R_{H} is proportional to the change of the heating temperature, thus the actual temperature during a heating phase.

At time point t₀ the heating of the vehicle mirror is switched on. The heating resistance R_{H} at the switch-on time point t₀ is R_{Hon}. It is assumed in this special instance that the temperature of the vehicle mirror at the switch-on time point to is below 0° C. Furthermore it is assumed that the vehicle mirror is iced-up and the ice adhering to the mirror surface obstructs the view of the vehicle occupant. The switched-on heating leads to the mirror and ice warming up.

At time point tₘ₁, the melting temperature of the ice is reached. Further heating for the time being only leads to a low heating temperature rise of the vehicle mirror. The larger part of the heating energy is used for the phase conversion of the ice into melting water and thus to the defrosting of the vehicle mirror. At time point tₘ₂ the ice has substantially cleared away. Between time points tₘ₁ and tₘ₂ the heating resistance R_{H} only rises by the amount ΔR_{HM}. The first intermediate phase between ice and melted water is shown shaded in FIG. 1a.

Since no phase conversion takes place subsequent energy supply leads to the vehicle mirror and the melted ice warming up. Certainly a part of the ice and melted ice will have already dripped off from the mirror so that the rising speed of the heating temperature at the end of melting tₘ₂ can differ from the rising speed before melting starts tₘ₁.

The second intermediate phase is caused by the evaporation of the water which covers the mirror surface. In order to dry the mirror a heating temperature clearly below 100° C. is thereby sufficient. Additional effects which may influence drying are for example the driving wind or the microscopic surface structure or surface energies of the mirror surface. The duration from the start tₑ₁ to the end tₑ₂ of the evaporation phase deviates in the normal case from the first intermediate phase (melting phase) as a result of the environmental conditions and can last longer or shorter than the melting phase. In an analogous way the heating resistance change ΔR_{He} of the evaporation phase differs from the heating resistance change ΔR_{Hm} of the melting phase.

Subsequently further energy supply leads to a further increase in the heating temperature as shown in shading in FIG. 1a. A further increase in the heating temperature is however often undesirable and in some cases has no further benefit to the vehicle occupant. In order to control the heating, threshold values Th_{R1} and Th_{R2} are fixed and compared with the actual heating resistance value R_{H.} Further threshold values are preferably determined from a value of the heating resistance R_{H} in the region of the intermediate phases ΔR_{Hm}, ΔR_{He}.

In order to determine these further threshold values the time change dR_{H}/dt of the heating resistance R_{H} is advantageously evaluated, as shown in FIG. 1b. FIG. 1b is in turn a diagrammatic illustration analogous with FIG. 1a and accordingly is subject to sharp fluctuations under real conditions as a result of changing atmospheric influences. The flank changes of the time change dR_{H}/dt are used to trigger an evaluation so that the heating resistance R_{H} is determined for the flank changes and its value is stored for a simultaneous or subsequent control of the heating. In addition the time values tₘ₁, tₘ₂, tₑ₁, tₑ₂ as well as the time differences (tₘ₂−tₘ₁, tₑ₂−tₑ₂) are advantageously stored and evaluated in connection with the threshold values Th_{R1}, Th_{R2} etc for control. By way of example for an only slight time difference between tₑ₂−tₑ₁ and the threshold values Th_{R1} and Th_{R2} through evaluation the interpretation is that no moisture is present on the mirror surface and the heating is to be switched off for a longer time period.

FIG. 1b shows diagrammatically that the rising speeds dR_{H}/dt of the two intermediate phases, the melting phase and the evaporation phase, can be different. Also the rising speeds dR_{H}/dt of the heating phases before or after the intermediate phase are under some circumstances different. For control, further threshold values Thₘ and Thₑ are provided or determined which are compared for evaluation with the rising speeds dR_{H}/dt. A control of the heating can take place additionally or alternatively in dependence on the rising speed dR_{H}/dt and the threshold values Thₘ and Thₑ.

FIG. 2 shows a diagrammatic block circuit diagram of a control device IC for controlling the heating of for example the vehicle wing mirror KSS. The control device IC is connected through a CAN bus or another bus, such as VAN, Token Ring etc to further function units EX of the vehicle. Further data such as for example on the operation of a window wiper are supplied to the control device IC through the CAN bus. The operation of the windscreen wiper is included by the control device IC into the evaluation so that for example rain is concluded and the mirror is heated at least temporarily up to evaporation temperature. Furthermore the control device IC is more advantageously connected to an input device for manually operating heating functions.

The control device IC is connected in series with the heating resistance R_{H} through which the heating current I_{H} flows, and is attached to the battery voltage U_{B}, for example to earth GND. For control the control device IC has a switch S with connected dedicated driver D. The driver D is connected in turn to a computer unit EU of the control device IC. A measuring unit MU of the control device IC is likewise connected to the heating resistance R_{H}. A voltage or current can be determined for example with the measuring unit MU. The measuring unit MU is furthermore connected to the computer unit EU for evaluation of the measured values. In order to determine the temperature-dependent heating resistance R_{H} or measured value the heating resistance Rₕ is switched at least temporarily as element of for example a measuring bridge which is part of the measuring unit MU. As an alternative to FIG. 2 the measuring unit MU can also be in active connection with a temperature sensor (not shown in FIG. 2) which is coupled thermally to the heating resistance R_{H} or to the function unit which is to be heated.

As an alternative in order to determine the temperature-dependent heating resistance R_{H} or the measured value, the heating resistance R_{H} is switched at least temporarily as element of a resonant circuit. The resonant circuit is thereby a part of the measuring unit MU. The heating resistance R_{H} is determined by means of the frequency of the resonant circuit. Apart from these configurations other measuring methods and measuring unit MU can also be used to determine the heating resistance R_{H}.

If the control device is constructed from purely analogue elements the evaluation and control can take place continuously in time. Advantageously the control device is equipped in addition to the analogue elements with a digital computer unit for evaluation and control. This enables the calculation of complex functions and inclusion of temperature-independent factors, such as the actuation of a windscreen wiper into the evaluation. In this case the computer unit is connected to a memory M, more particularly a non-volatile memory (EEPROM) for storing for example the threshold values Thₘ and Thₑ.

In addition the digital control device IC has a clock C, a timer C or impulse generator C as time basis. The time basis C serves on the one hand for keying the digital elements of the control device IC, thus also for determining or calculating the times t₀, tₘ₁, tₘ₂, tₑ₁, and tₑ₂. Determining the measured values of the measuring unit MU thereby takes place time-discrete. By way of example the time change dR_{H}/dt of the heating resistance or heating temperature is determined from the difference between two successive time-discrete measured values.

Detailed diagrammatic examples of a control device IC are shown in FIGS. 3a and FIG. 3b. FIG. 3a shows a conventional solution of individual structural elements. The heating resistance R_{H} is connected in series with a shunt-resistance R_{S} or measuring resistance R_{S}. The shunt resistance R_{S} is thermally uncoupled from the heating resistance R_{H} and has in the ideal case no or only a slight temperature-dependence. The heating resistance R_{H} is determined from the heating current I_{H} and a heating voltage U_{B}-U_{RS}. The heating current I_{H} is determined from U_{RS}/R_{S}. The voltage drop at the shunt-resistance R_{S} is converted by the analogue-digital converter ADC into digital discrete measured values and evaluated by the computer unit EU. The computer unit EU has a counter C₁ which is connected to a resonant quartz Q₁ to generate a time basis. The computer unit EU with the counter C₁ is advantageously a micro computer unit.

An output of the micro computer unit EU is connected to a PNP transistor D₁ for driving the relay coil L_{S1}. A relay switch S₁ is mechanically coupled to the relay coil L_{S1} and can be used to switch the heating current I_{H} in heating intervals which are to be controlled. Furthermore the micro computer unit EU is connected through a BUS to an external temperature sensor eTS which measures the air temperature of the surroundings. The external temperature sensor eTS is used for air temperatures above freezing point (0° C.) not to switch on the heating since no ice is present on the mirror which impairs the occupant's view.

FIG. 3b shows a solution which enables an integration of the control device IC in so-called smart power technology. For this the control device IC has an integrated switching circuit with a computer unit EU and a power semi conductor LT₁ controllable by the computer unit EU in smart-power technology. The control device IC is in turn connected through a BUS to further function units such as a clock eCLK and an air temperature sensor eTS of the vehicle. The computer unit EU is in turn connected to an analogue digital converter ADC for detecting the measured values.

For control, the computer unit EU has means for a pulse-width modulation PWM. The output OUT_{LT1} of the computer unit EU with the pulse-width modulated control signals is connected to the gate of a power MOSFETs LT₁ for controlling the heating. In order to generate a measured signal the control device IC has a substantially temperature-independent constant current source S_{IK} which is connected at least temporarily to the heating resistance R_{H}. The constant current I_{K} of the constant current source S_{IK} generates a heating temperature dependent measured voltage UM which is measured by the analogue digital converter ADC. The constant current source S_{IK} is controllable through the control output OUT_{SIK} of the computer unit EU, for example for the reduction of the closed-circuit current. Advantageously the power transistor LT₁ and the constant current source S_{IK} consist of a single MOSFET whose gate voltage is varied accordingly for a constant current I_{K} or for the full heating current I_{H}. As an alternative to the illustrated Low-side driver 1 a high-side driver is used so that the heating resistance R_{H} is connected between the high-side driver and earth GND.

In order to control several heatings which can also heat different functional units, through the control device IC the said control device IC has a multiplexer (not shown in the drawings) which connects the measuring unit MU of the control device IC cyclically to the heating resistance R_{H} which is to be measured. In addition the control device IC has several power transistors LT₁ in order to control the individual heating currents I_{H}.

A diagrammatic plan in the form of a flow chart of part of a program of the computer unit EU is shown in FIGS. 4 and 4′. FIG. 4′ is thereby only a continuation of FIG. 4. In step 1 the heating is started up. Starting up the heating is carried out for example by the vehicle occupant who would like to defrost the ice sticking to the vehicle wing mirror. Alternatively the heating can also be started up automatically when the external temperature of the air is below 0° C. for example or the windscreen wipers are switched on and signal rain.

Step 2 enables interrogation as to whether an external parameter Tₑₓ is below a threshold value T_{exth.} By way of example the external parameter Tₑₓ is an outside temperature or information that the vehicle has been standing in a garage. In step 3 the heating is stopped accordingly. In step 4 a security question is asked. If the heating temperature T_{S} is above a threshold value T_{Smax} which represents the maximum permissible heating temperature then the heating is immediately stopped in step 5. Otherwise if Tₛ<T_{Smax} then the heating is controlled in step 6 and electric power is converted into heat.

After a certain heating duration in step 7 the time change dR_{H}/dt of the heating resistance is evaluated and the time change dR_{H}/dt is compared with a threshold value Thₘ for melting the ice. If the time change dR_{H}/dt is greater than the threshold value Thₘ then steps 4 and 5 and 6 respectively follow and in turn 7 again after a certain heating duration. If the time change dR_{H}/dt is less than the threshold value Thₘ then the actual value of the heating resistance R_{H}(t) is stored as the threshold value R_{Hm}. Steps 4′ and 5′ and 6′ respectively then follow similar to steps 4, 5 and 6.

In step 9 the time change dR_{H}/dt of the heating resistance R_{H} is again evaluated and the time change dR_{H}/dt is compared with the threshold value Thₘ. If the time change dR_{H}/dt of the heating resistance R_{H} is substantially greater than the threshold value Thₘ then the actual value of the heating resistance R_{H}(t) is stored as threshold value Th_{R1}. Steps 4″, 5″ and 6″ apply analogous with steps 4, 5 and 6.

Step 12 is to be viewed analogous with step 7. In step 12 the time change dR_{H}/dt is compared with a threshold value Thₑ for evaporating moisture adhering to the mirror. The actual value of the heating resistance R_{H}(t) is stored as Th_{R2} or as evaporation value R_{He}.

In the following steps (not shown) the heating can be switched off for example. The stored threshold values Thₘ, Thₑ, Th_{R2} and Th_{R1} serve for evaluation and control of subsequent heating processes, by way of example after a new start-up of the vehicle.

If for example the vehicle is started up anew (the following method steps are not contained in the figures) the external temperature is detected as below 0° C. The heating resistance R_{H} is supplied with current for heating. If on reaching the threshold value R_{Hn} the time change dR_{H}/dt of the heating resistance R_{H} does not decrease, for example below the threshold value Thₘ then the heating is stopped. The mirror is apparently not iced up.

As an alternative to the preferred developments previously mentioned the heating temperature is determined by a heating temperature sensor thermally coupled to the function unit. The heating temperature sensor can be made independently of the manufacturing tolerances of the heating resistance and thus a particularly accurate determining of the actual temperature measured at the heating temperature sensor is possible. However this requires a very good thermal coupling between the heating resistance and the heating temperature sensor.

List of Reference Numbers

T Time

T₀ Start of heating

Tₘ₁ Time start of melting

Tₘ₂ Time end of melting

Tₑ₁ Time beginning of evaporation

Tₑ₂ Time end of evaporation

R_{H}, R_{H1}, R_{H2}, R_{H3} Heating resistance

ΔR_{Hm} Heating resistance difference during melting

R_{He} Heating resistance difference during evaporation

R_{Hon} Heating resistance value at start of heating

Th_{R1},Th_{R2} Threshold value

Thₑ, Thₘ Threshold value

dR_{H}/dt Derivation of heating resistance after time

IC Control device

U_{B} Voltage of vehicle battery

GND Earth

BUS Serial or parallel data bus (CAN)

EX External unit

EU Computer unit

MU Measuring unit

D Driver

S Switch

M Memory

C Cycle transmitter or impulse transmitter, clock

ETS External temperature sensor

C₁ Counter unit

Q₁ Resonant quartz

D₁ Driver transistor (PNP)

L_{S1} Relay coil to switch S₁

R_{S} Measuring resistance or shunt resistance

ADC Analogue digital converter

eCLK External clock, external cycle transmitter or impulse transmitter

PWM Unit for pulse width modulation

Out_{LR1} Control output for power transistor

LT₁ Power transistor (MOSFET)

OUt_{Sik} Control output constant current source

S_{IK} Constant current source, constant current drop

I_{K} Constant current

U_{M} Measuring potential, measuring voltage against earth

KSS Vehicle wing mirror

Tₑₓ Surrounding air temperature

Tₑₓₜₕ Threshold value for the surrounding air temperature

Tₛ Mirror temperature

Tₛₘₐₓ Threshold value for maximum mirror temperature

R_{Hm} Heating resistance for melting phase

R_{He} Heating resistance for the evaporation phase

1. Method for controlling heating of a function unit on a motor vehicle, more particularly an outside mirror, lock, or window pane, with at least one heating element (R_{H}) whose heating power can be electrically controlled, wherein
the heating of the function unit is started manually or automatically;
an actual temperature or a parameter (R_{H},U_{H},I_{H}, Uₘ, Iₘ) dependent on the actual temperature is determined;
the time path of the actual temperature or the parameter (R_{H},U_{H},I_{H}, Uₘ, Iₘ) dependent on the actual temperature is determined and the characteristic features of this time path determining the phase transition of water are evaluated, and
the heating power of the heating element (R_{H}) is controlled in dependence on the evaluation of these characteristic features.

2. Method according to claim 1,
characterised in that
the actual temperature or the parameters (R_{H},U_{H},I_{H}, Uₘ, Iₘ) dependent on the actual temperature is determined before and/or after a heating period.

3. Method according to one of the preceding claims,
characterised in that
prior to the heating period the phase transition of water is determined and the heating is automatically started and/or the heating power is raised in dependence on the determined phase transition.

4. Method according to claim 1,
characterised in that
the actual temperature or the parameter (R_{H},U_{H},I_{H}, Uₘ, Iₘ) dependent on the actual temperature is only determined during a heating period.

5. Method according to one of the preceding claims,
characterised in that
different falling and/or rising speeds of the actual temperature or of the parameter (R_{H},U_{H},I_{H}, Uₘ, Iₘ) dependent on the actual temperature, caused by phase transition of water are evaluated as characteristic features.

6. Method according to one of the preceding claims,
characterised in that
a minimum of the time change (dR_{H}/dt) of the actual temperature or of the parameter (R_{H},U_{H},I_{H}, Uₘ, Iₘ) dependent on the actual temperature, caused by a phase transition of water, is determined as characteristic feature.

7. Method according to one of the preceding claims, with a temperature-dependent heating resistance (R_{H}) as heating element (R_{H}) through which a heating current (I_{H}) flows for heating,
characterised in that
as parameter (R_{H},U_{H},I_{H}, Uₘ, Iₘ) dependent on the actual temperature is determined the temperature-dependent heating resistance (R_{H}) or a measured value (U_{H},I_{H}, Uₘ, Iₘ) dependent on the temperature-dependent heating resistance (R_{H}), and the heating power is controlled with reference to the determined heating resistance (R_{H}) or the determined measured value (U_{H},I_{H}, Uₘ, Iₘ).

8. Method according to claim 7,
characterised in that
in order to control the heating additionally the time change (dR_{H}/dt) of the heating resistance (R_{H}) or the measured value (U_{H},I_{H}, Uₘ, Iₘ) dependent on the heating resistance (R_{H}) is evaluated whereby in particular a value (R_{HM}) of the heating resistance (R_{H}) or the measured value (U_{H},I_{H}, Uₘ, Iₘ) dependent on the heating resistance (R_{H}) for a minimum of the time change (dR_{H}/dt) is determined and for subsequent evaluations the actual heating resistance (R_{H}) is compared with the value (R_{HM}) or the measured value (U_{H},I_{H}, Uₘ, Iₘ).

9. Method according to one of the preceding claims,
characterised in that
the value (R_{HM}) of the actual temperature or the parameter (R_{H},U_{H},I_{H}, Uₘ, Iₘ) dependent on the actual temperature , more particularly the resistance value (R_{HM}) of the heating resistance (R_{H}) or the measured value of the parameter (U_{H},I_{H}, Uₘ, Iₘ) dependent on the heating resistance (R_{H}) for a specific phase transition of water is stored.

10. Method according to one of claims 8 or 9,
characterised in that
the heating is controlled from the value (R_{Hm}) and temperature coefficient of the heating resistance (R_{H}) in that from in particular the value (R_{Hm}) at least one threshold value (Th_{R2},Th_{R1}) is determined for control, and for control the heating resistance (R_{H}) or the measured value (U_{H},I_{H}, Uₘ, Iₘ) is compared by a comparator with a threshold value (R_{He}, R_{Hm}, Thₑ, Thₘ, Th_{R2}, Th_{R1}), and the heating is then controlled from this comparison.

11. Method according to one of claims 8 to 10,
characterised in that
values (R_{Hm}) or measured values of the heating resistance (R_{H}) or the parameter (U_{H},I_{H}, Uₘ, Iₘ) are compared by a window comparator as comparator with an upper threshold value (Tₕₑ, Th_{R2}) and a lower threshold value (Tₕₘ, Th_{R1}) and the heating is switched off on exceeding the upper threshold value (Tₕₑ,Th_{R2}) and is switched on when falling below the lower threshold value (Tₕₘ,Th_{R1}).

12. Method according to one of the preceding claims,
characterised in that
for controlling the heating the heating current (I_{H}) is switched on at intervals whereby in particular for controlling the heating the heating current (I_{H}) is regulated by means of a pulse width modulation.

13. Method according to one of claims 7 to 12,
characterised in that
the heating resistance (R_{H}) is determined from the heating current (I_{H}) and a heating voltage in that
to determine the temperature-dependent heating resistance (R_{H}) or the measured value a constant current (I_{K}) (independent of the temperature) flows at least temporarily through the heating resistance (R_{H}), and/or to determine the temperature-dependent heating resistance (R_{H}) or the measured value the heating resistance (R_{H}) is switched at least temporarily as element of a measuring bridge, and the heating resistance (R_{H}) is determined by means of the measuring bridge, or to determine the temperature-dependent heating resistance (R_{H}) or the measured value, the heating resistance (R_{H}) is switched at least temporarily as element of a resonant circuit, and
the heating resistance (R_{H}) is determined by means of the frequency of the resonant circuit.

14. Method according to one of the preceding claims,
characterized in that
a temperature sensor (eTS) of the vehicle which measures an air temperature independent of the heating is additionally evaluated for controlling the heating so that in particular different heating modes of the heating of the function unit are started for associated air temperatures.

15. Heating of a function unit on a motor vehicle, more particularly an outside mirror, lock or window pane with at least one heating element (R_{H}) whose heating power can be electrically controlled,
characterised by
a control device (IC) for carrying out the method according to one of the preceding claims.

16. Heating according to claim 15,
characterised in that
the heating element (R_{H}) is a temperature-resistant heating resistance (R_{H}) through which a heating current (I_{H}) flows for heating,
the temperature-dependent heating resistance (R_{H}) is connected to a measuring unit (MU) of the control device (IC) for determining the temperature-dependent heating resistance (R_{H}) or a measured value (U_{H},I_{H}, Uₘ, Iₘ) dependent on the temperature-dependent heating resistance (R_{H}), and
the heating resistance (R_{H}) for control is connected to a control element (S,S₁,LT₁) of the control device (IC).

17. Heating according to one of claims 15 or 16,
characterised in that
to determine a time change (dR_{H}/dt) of the resistance values of the heating resistance (R_{H}) the control device (IC) is connected to a time transmitter (C ) or an impulse transmitter (C ) and/or
the measuring unit (MU) has an analogue-digital converter (ADC) whose analogue input is connected to the heating resistance (R_{H}).

18. Heating according to one of claims 15 to 17,
characteris d in that
the control device (IC) has a memory (M) for storing a value (R_{He}, R_{Hm}) of the actual temperature or parameter (R_{H},U_{H},I_{H}, Uₘ, Iₘ) for a characteristic of the time path of the actual temperature, and/or
for determining the heating resistance (R_{H}) the control device (IC) has a constant voltage source (S_{IK}) which is connected at least temporarily to the heating resistance (R_{H}) whereby in particular
the control device (IC) has an integrated switch circuit with a computer and a power semi conductor controllable by the computer in smart-power technology.
